(19) United States
(12) Patent Application Publication
(10) Pub. No.: US 2026/0228606 A1
(43) Pub. Date: Aug. 6, 2026

(54) GENERATING SYNTHETIC MESSAGES FOR TRAINING AN ARTIFICIAL INTELLIGENCE MODEL OF A COMMUNICATIONS SERVICES PLATFORM

(71) Applicant: Twilio Inc., San Francisco, CA (US)

(72) Inventors: Sachin Narayan Nagargoje, Bengaluru (IN); Rajiv Chemudupati, Bangalore (IN); Samarpan Das, Bangalore (IN); Sayantan Das, Bengaluru (IN); Ashish Pal, Bangalore (IN); Shamik Ray, Kolkata (IN)

(21) Appl. No.: 19/043,987

(22) Filed: Feb. 3, 2025

(51) Int. Cl. G06N 20/00; H04L 51/21

(52) U.S. Cl. CPC G06N 20/00; H04L 51/21

(57) ABSTRACT

A method for generating synthetic messages for training an AI model of a communications services platform includes generating, by a communication services platform, one or more example messages simulating communications of a customer of the platform with a user associated with the customer. Each example message may be associated with a first message category. The method includes generating a prompt that includes a command to generate a synthetic message based on the example messages. The method includes causing a first AI model, in response to receiving the prompt, to generate one or more synthetic messages. The method includes generating a training dataset that includes the synthetic messages. Each item of training data of the training dataset includes the first message category as a target output label. The method includes training, using the training dataset, a second AI model to classify input messages into two or more message categories.

### TECHNICAL FIELD

Aspects and implementations of the disclosure relate to computer software, and more specifically, to systems and methods for generating synthetic messages for training an artificial intelligence model of a communications services platform.

### BACKGROUND

Entities can use communication services platforms to manage their communications, for example, via text messages. A communication services platform may classify text messages sent by entities. The classification may assist the communication services platform in determining a use case of the message and determining whether the message complies with the platform's acceptable use policy or applicable laws and regulations.

### BRIEF DESCRIPTION OF THE DRAWINGS

Aspects and implementations of the disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture, in accordance with some implementations of the disclosure.

FIG. 2 illustrates an example flow of data for generating synthetic messages for training an artificial intelligence (AI) model of a communications services platform, in accordance with some implementations of the disclosure.

FIG. 3 depicts a flow diagram of an example method for generating synthetic messages for training an AI model of a communications services platform, in accordance with some implementations of the disclosure.

FIG. 4 is a block diagram illustrating an exemplary computer system, in accordance with some implementations of the disclosure.

### DETAILED DESCRIPTION

A communication services platform, such as a Software as a Service (Saas) platform, can offer various communication services to users. For example, a SaaS platform can offer messaging service tools that facilitate messaging conversations, e.g., the sending and/or receiving of messages, such as short message service (SMS) messages, multimedia messaging service (MMS) messages, and/or instant messaging (IM) messages, to and from devices via various communication channels. The communication services platform can offer voice call service tools that facilitate voice conversations, e.g., the making and receiving of voice calls using various protocols, such as Voice over Internet Protocol (VOIP), various mobile communications protocols, or Session Initiation Protocol (SIP).

In some jurisdictions, applicable law may prevent sending messages related to certain topics during a certain time range (e.g., sending marketing messages between 8 p.m. and 8 a.m. local time). In order to prevent possible violations of such laws or regulations, or in order to enforce the communication services platform's acceptable use policy or other types of policies, the communication services platform may classify the messages being forwarded and use the message classifications for determining whether a particular message may be forwarded to the destination at the current time of day. In some implementations, message classification may be performed by trainable classifiers; however, the communication services platform may lack training data that can be used for training such classifiers. In some instances, using live messages sent by a customer of the platform to configure the automated processes may not be possible because of regulatory requirements. Furthermore, messages sent by one customer may be significantly different from messages sent by another customer, such that using the first customer's messages for comparison to a second customer's messages may produce inaccurate classifications.

Aspects of the disclosure address the above-mentioned and other challenges by implementing systems and methods that generate synthetic messages for training an AI model to classify messages sent by a customer of the communication services platform. The platform may then use the trained AI model to classify outgoing messages and determine, based on the classification, whether transmitting a particular message would comply with the platform's acceptable use policy or relevant laws and regulations. Non-compliant messages may be discarded or may be queued for sending during the next compliant time window.

Aspects of the disclosure include the communication services platform generating initial example messages that simulate messages sent by a customer of the platform to an end user of the customer. A simulated message may resemble real messages sent to an actual end user of the customer. For example, a simulated message can contain a one-time password (OTP) that the recipient end user could use to log into a customer's website. In another example, a simulated message can include marketing or promotional content targeting the recipient end user. Each simulated message may belong to a certain message category. Examples of message categories can include verification messages, marketing messages, announcement messages, or emergency messages.

The communication services platform can include the simulated messages as examples in a prompt for a generative AI model. The simulated messages included in the prompt may belong to the same message category (e.g., all of the simulated messages included as example messages in the prompt may belong to the verification message category). The generative AI prompt may include instructions for a generative AI model (e.g., a large language model (LLM)) to generate multiple synthetic messages that are similar to the simulated messages included in the prompt. For example, the prompt may include the following introduction: “The following are example messages sent from a customer to an end user of the customer:” followed by the example simulated messages. The example prompt may conclude by the following command: “Generate several messages that are similar to these example messages.”

The communication services platform may input the generated prompt into a generative AI model, thus causing the generative AI model to produce multiple synthetic messages. The synthetic messages may belong to the same message category as the example messages used in the prompt. The synthetic messages may be practically indistinguishable from real messages from a platform customer to its end users. For example, a synthetic verification messages may include the following text: “Your one-time password is 836551. Please enter this number on our login page to complete your login process.” In another example, a synthetic marketing message may include the text, “Winter coats are 20% off September 1-15. Please visit our location in downtown Gainesville and try one on today! Reply ‘STOP’ to stop receiving these messages.”

The platform may repeat the process of generating example messages, generating a prompt that includes the example messages, and using the prompt with the generative AI model to generate different sets of synthetic messages. Each set of synthetic messages may belong to a respective message category. For example, a first set of synthetic messages may belong to the verification message category, and a second set of synthetic messages may belong to a marketing message category. The message category to which a message belongs may be used as a target output label when the platform generates an item of a training dataset based on the message. The platform may use different generative AI models, with different configurations, to produce different sets of synthetic messages, which allows the platform to produce a robust variety of synthetic messages.

The communication services platform may organize the synthetic messages that were output by the generative AI model into a training dataset. Each item of the training dataset can include a synthetic message and a message category corresponding to the synthetic message (e.g., verification, marketing, emergency, healthcare, etc.). The platform may use the training dataset to train another AI model that classifies input messages into two or more categories. Once trained, this second AI model can receive outgoing messages provided by customers to the platform and can classify the outgoing messages. If, based on a message's category and the current time of day, transmitting the message does not comply with the platform's acceptable use policy or applicable laws or regulations, the platform may delay or prevent the transmission of the message to the recipient user.

As noted above, a technical problem addressed by implementations of the disclosure is efficient, accurate, and automated real-time detection of non-compliant messages that customers provide to the communication services platform for forwarding to respective end users. The technical solution to the above-identified technical problem utilizes an AI model to classify such outgoing messages. The AI model is trained on a training dataset that includes synthetic messages generated by a second AI model (e.g., an LLM). The second AI model can generate a large volume of synthetic messages quickly and with realistic details. Thus, a technical effect may include improving the efficiency and accuracy of the classification AI model via training on the training data that includes the synthetic messages.

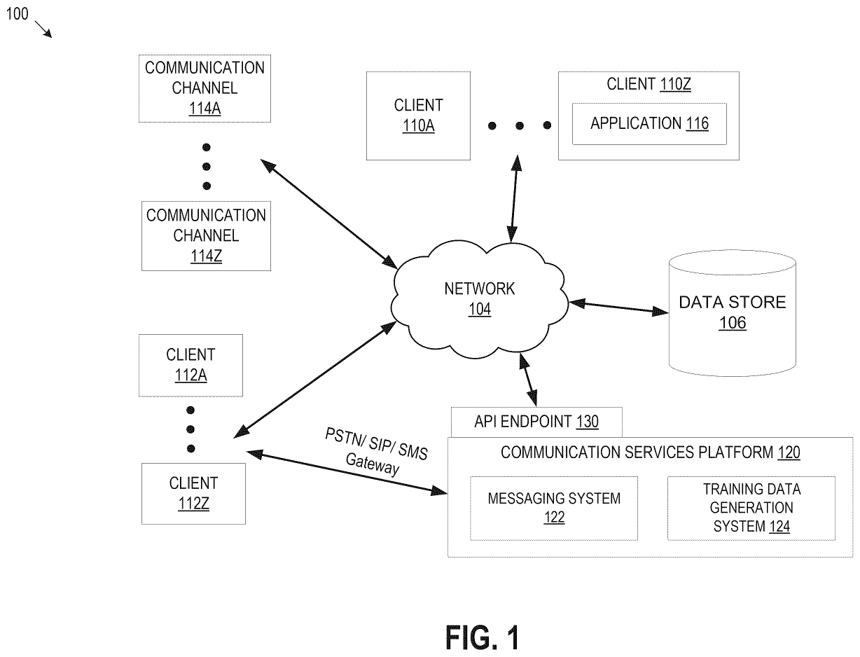

FIG. 1 illustrates an example system architecture 100, in accordance with some implementations of the disclosure. The system architecture 100 (also referred to as “system” herein) includes a network 104, a data store 106, one or more client devices 110A-110Z, one or more client devices 112A-112Z, one or more communication channels 114A-114Z, and a communication services platform 120 (also referred to as the “platform 120” herein). The client devices 110A-Z, the client devices 112A-112Z, and/or the communication channels 114A-114Z may be communicatively coupled to the platform 120 via the network 104. The data store 106 may be communicatively coupled to the platform 120 via the network.

In some implementations, the network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 106 is a persistent storage that is capable of storing data as well as data structures to tag, organize, and index the data. The data store 106 may be hosted by one or more storage devices, such as main memory, magnetic or optical storage-based disks, tapes or hard drives, network-attached storage (NAS), storage area network (SAN), and so forth. In some implementations, the data store 106 may be a network-attached file server, while in other implementations, the data store 106 may be some other type of persistent storage such as an object-oriented database, a relational database, and so forth, that may be hosted by the communication services platform 120 or one or more different machines coupled to the communication services platform 120 via the network 104.

The client devices 110A-Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, a client device 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, the client devices 110A-Z may also be referred to as “user devices.”

In some implementations, a client device 110, such as the client device 110Z, can implement or include one or more applications, such as the application 116 (also referred to as “client application 116” herein) executed at the client device 110Z. In some implementations, the application 116 can be used to communicate (e.g., send and receive information) with communication services platform 120. In some implementations, application 116 can implement user interfaces (e.g., graphical user interfaces (GUIs)) that may be webpages rendered by a web browser and displayed on the client device 110Z in a web browser window. In another implementation, the user interfaces of the application 116 may be included in a stand-alone application downloaded to the client device 110Z and natively running on the client device 110Z (also referred to as a “native application” or “native client application” herein).

In some implementations, one or more client devices 110 can communicate with the communication services platform 120 using one or more function calls, such as application programming interface (API) function calls (also referred to as “API calls” herein). For example, the function calls can be identified in a request using one or more application layer protocols, such a HyperText Transfer Protocol (HTTP) (or HTTP secure (HTTPS)), and that are sent to the communication services platform 120 from the client device 110Z implementing the application 116. In some implementations, the communication services platform 120 can respond to the requests from the client device 110Z by using one or more API responses using an application layer protocol. Similarly, communication services platform 120 can communicate with one or more communication channels 114A-114Z using API function calls.

In some implementations, a communication channel 114 can be implemented by software and/or hardware through which voice calls or messages can be sent to recipient devices (e.g., organizations different from communication services platform 120). In some implementations, the communication services offered by communication channels 114A-114Z can be integrated into the communication services platform 120. In some implementations, the communication services offered by the communication channels 114A-114Z can include voice communication services, messaging services, or other types of communication services. In some implementations, messaging services can include one or more of a SMS implemented by an SMS channel, a MMS offered by an MMS channel, or an IM service (e.g., chat messaging) offered by an IM service channel. In some implementations, communication channels 114A-114Z can also include a voice channel. For example, the voice channel may implement an application to send or receive voice calls. In another example, the voice channel may be implemented by a telecommunication service provider, such as PSTN provider, mobile communication services provider, and/or VoIP services provider.

In some implementations, one or more of client devices 110 can be identified by a uniform resource identifier (URI), such as a uniform resource locator (URL). For example, the communication services platform 120 can send an API call to the client device 110Z addressed to a URL specific to the client device 110Z. In some implementations, the communication services platform 120 can be identified by a URI. For instance, the API call sent by a client device 110 to the communication services platform 120 can be directed to the URL of the communication services platform 120.

In some implementations, a communication endpoint may be a client device of the client devices 112A-Z (generally referred to as “client device(s) 112” herein). The client devices 112 may be similar to client devices 110. A client device 112 may include a device that a user can utilize to communicate with another communication endpoint. A communication endpoint may include a telephony device. A telephony device can include a Public Switched Telephone Network (PSTN)-connected device, such as a cellular phone or messaging-enabled satellite phone. In some implementations, a telephony device can also include an internet addressable voice device (e.g., non-PSTN telephony device), such as messaging-enabled VoIP phones or SIP devices, for example. In some implementations, a telephony device can include one or more messaging devices, such as a SMS network device that, for example, uses a cellular service to exchange SMS messages or MMS messages. A communication endpoint may include other types of devices, such as a landline phone. A communication endpoint can be identified by an identifier (e.g., a phone number, a network address, a universal resource identifier (URL), a numeric identifier, or an alphanumeric string).

In some implementations, the communication services platform 120 may provide communication services that include, but are not limited to, voice services, messaging services (e.g., SMS services or MMS services), email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

The communication services platform 120 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, the communication services platform 120 may include a plurality of computing devices that together may comprise a hosted computing resource, a grid computing resource or any other distributed computing arrangement. In some implementations, the communication services platform 120 may correspond to an elastic computing resource where the allotted capacity of processing, network, storage, or other computing-related resources may vary over time.

In an illustrative example, communication services platform 120 can include a SaaS platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In one implementation, an organization may access the communication services platform 120 as a customer of the platform 120. An example of an organization may be an entity, such as a legal entity. An example of a legal entity includes a corporation (e.g., authorized by law to act as a single entity or legal entity). In some implementations, a customer may be represented as a single individual. However, other implementations of the disclosure encompass a customer being an entity controlled by a set of persons and/or an automated source. For example, a set of individual users federated as one or more departments in an organization may be considered a customer.

In some implementations, an organization can be associated with an account (e.g., organizational account) of the communication services platform 120. Within the particular account of the organization, one or more accounts of the communication services platform 120 may be associated with different users of the organization. In some implementations, the accounts are organized in a hierarchical structure where the organizational account is the root at the top of the hierarchy and the user accounts are nested under the organizational account. The communication services platform 120 may include an account management system configured to manage accounts of the communication services platform 120. Managing accounts may include functionality related to account creation, account deactivation, account suspension, account modification, or other functionality.

In some implementations, the communication services platform 120 can provision identifiers of communication endpoints to an organization's account and assign the identifiers to various user accounts associated with the organization. Such identifiers may include telephone numbers (e.g., 10-digit long code or short code). The assignment of identifiers can be flexible such that the assignment of an identifier can be one-to-one (e.g., one identifier to one user account) or one to many (e.g., one identifier to many user accounts).

In some implementations, the communication services platform 120 further includes a messaging system 122. The messaging system 122 may include hardware and/or software The messaging system 122 may include hardware and/or software that functions to interface with one or more communication networks and/or services for facilitating SMS, MMS, IM, and/or other carrier-based messages. The messaging system 122 may receive a message forwarding request from a client device 110 of a customer. The messaging system 122 may cause the platform 120 to forward one or more messages (e.g., SMS messages, MMS messages, and/or IM messages) based on the message forwarding request. A message forwarding request can include a data object characterizing the properties of a message. In some implementations, the messaging system 122 is associated with message forwarding requests that are programmatically initiated (e.g., an application-to-person (A2P) message).

In some implementations, a message forwarding request can include one or more of one or more destination endpoints, one or more origin endpoints, and a message payload. In some implementations, one or more of these properties may be specified indirectly such as through system or account configuration or identifier (e.g., messaging conversation identifier). For example, all messages may be automatically assigned an origin endpoint that is associated with an account. In some implementations, the message payload can include any suitable type of media content including, text, audio, image data, video data, multimedia, interactive media, data, and/or any suitable type of message content.

In some implementations, the messaging system 122 may determine whether sending a message as requested by a message forwarding request complies with an acceptable use policy of the communication services platform 120 or with applicable laws or regulations. For example, applicable law may prevent sending messages related to certain topics during a certain time range (e.g., sending marketing messages between 8 p.m. and 8 a.m. local time). Responsive to determining that sending the message would comply with the acceptable use policy and/or applicable laws and regulations, the messaging system 122 may cause the message to be sent using the platform 120. However, responsive to determining that sending the message would not comply with the acceptable use policy and/or applicable laws and regulations, the messaging system 122 may prevent transmission of the message or may delay the transmission of the message.

In one implementation, the messaging system 122 may employ an AI model that classifies a message of a message forwarding request into one or more message categories that reflect respective use cases. The AI model may classify a message based on the message content. The messaging system 122 may use the classification of the message to determine whether sending the message complies with the acceptable use policy of the platform 120 and/or applicable laws and regulations. For example, the AI model may determine, based on the message content of a message, that the message's classification is a marketing message. The messaging system 122 may determine that the local time for the recipient user of the message is 1 a.m. The messaging system 122 may determine that sending a marketing message between 8 p.m. and 8 a.m. does not comply with applicable law. Thus, the messaging system 122 may delay the sending of the message.

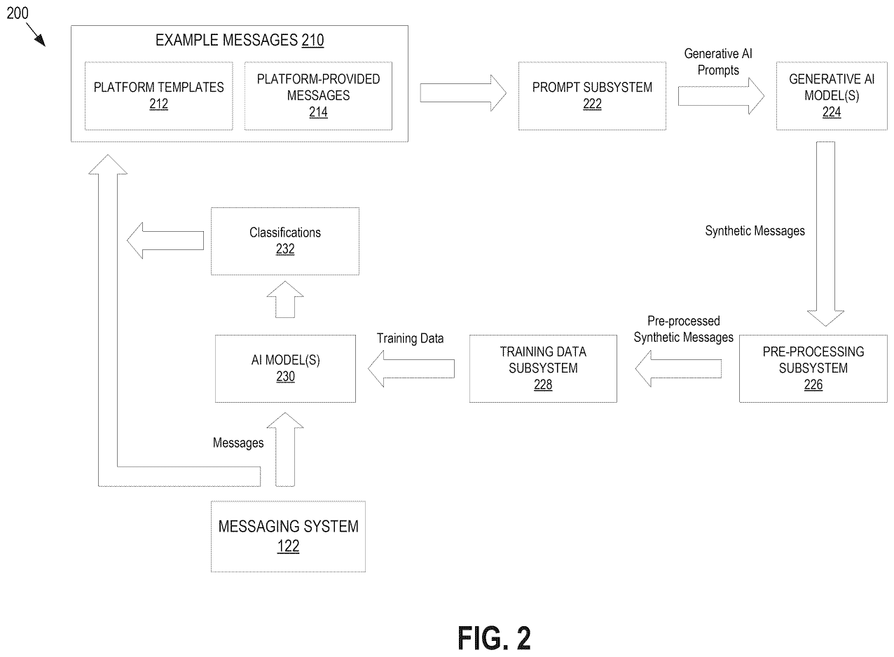

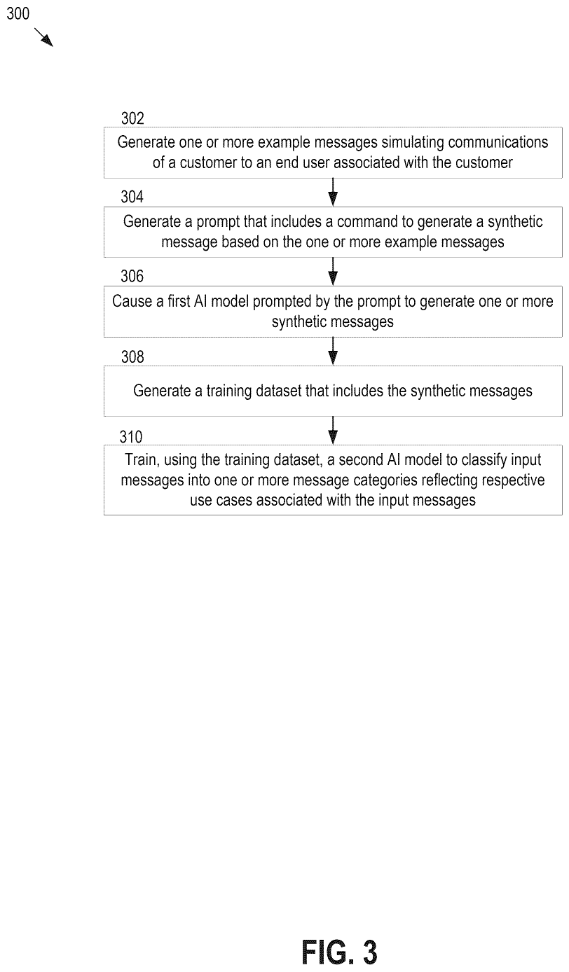

In one or more implementations, the communication services platform 120 further includes a training data generation system 124. The training data generation system 124 may include hardware and/or software configured to generate training data for the AI model of the messaging system 122, discussed above. The training data generation system 124 may include a second AI model (e.g., an LLM), or the training data generation system 124 may be in data communication with the second AI model. The training data generation system 124 may use example messages to generate prompts for the second AI model, and the second AI model may generate multiple synthetic messages that the training data generation system 124 uses to create training datasets for the AI model of the messaging system 122. A synthetic message may include a message generated by software and not by a human. Further details regarding the training data generation system 124 are provided below in relation to FIG. 2 and FIG. 3.

In some implementations, the communication services platform 120 provides one or more API endpoints 130 that can expose services, functionality or content of the communication services platform 120 to one or more of client devices 110 or communication channels 114A-114Z. In some implementations, an API endpoint 130 can be an endpoint of a communication channel in which the other endpoint can be implemented by another system, such as the client device 110Z or communication channel 114Z. In some implementations, the API endpoint 130 can include or be accessed using a resource locator, such a universal resource locator (URL), of a server or service. The API endpoint 130 can receive requests from other systems, and in some cases, return a response with information responsive to the request. In some implementations, HTTP or HTTPS methods can be used to communicate to and from API endpoint 130.

In some implementations, the API endpoint 130 (also referred to as a “request interface” herein) can function as a computer interface through which communication requests, such as message and/or voice requests, are received and/or created. The communication services platform 120 may include one or more types of API endpoints.

In some implementations, the API endpoint 130 can include a messaging API whereby external entities or systems can send a communication to create message content and/or request sending of a message. The API may be used in programmatically creating message content and/or requesting sending of one or more messages. In some implementations, the API is implemented in connection with a multitenant communication service wherein different accounts (e.g., authenticated entities) can submit independent requests. These requests made through the API can be managed with consideration of other requests made within an account and/or across multiple accounts on the communication service.

In some implementations, the API of the API endpoint 130 may be used in initiating general messaging or communication requests. For example, a messaging request may indicate one or more destination endpoints (e.g., as identified by recipient phone numbers), message content (e.g., text and/or media content), and possibly an origin endpoint (e.g., as identified by a phone number to use as the “sending” phone number).

In some implementations, the API of the API endpoint 130 may be any suitable type of API such as a Representational State Transfer (REST) API, a GraphQL API, a Simple Object Access Protocol (SOAP) API, and/or any suitable type of API. In some implementations, the communication services platform 120 can expose through the API, a set of API resources which when addressed may be used for requesting different actions, inspecting state or data, and/or otherwise interacting with the communication platform.

In some implementations, a REST API and/or another type of API may work according to an application layer request and response model. An application layer request and response model may use HTTP, Hypertext Transfer Protocol Secure (HTTPS), SPDY, or any suitable application layer protocol. Herein, HTTP-based protocol is described for purposes of illustration, the application layer may use other protocols. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, the API endpoint 130 can include a request instruction module that can be called within an application, script, or other computer instruction execution. For example, a computing platform may support the execution of a set of program instructions where at least one instruction within a script or other application logic is used in specifying a message forwarding request and communicating that request.

In some implementations, the API endpoint 130 can include a console, administrator interface, or other suitable type of user interface. Such a user-facing interface can be a graphical user interface. Such a user interface may additionally work in connection with a programmatic interface.

In some implementations, one or more APIs that the application 116 executing on a desktop client device (e.g., a desktop application) uses to access the messaging system 122 can be different APIs than the APIs used by the application 116 executed on a mobile client device (e.g., mobile application) to access the messaging system 122. In one implementation, the APIs used to communicate between the messaging system 122 and other systems of the communication services platform 120 may be private APIs that are not accessible by client devices 110 (or client devices 112).

Although implementations of the disclosure are discussed in terms of communication service platforms, implementations may also be generally applied to any type of platform, system or service. Furthermore, in general, functions described in some implementations as being performed by the communication services platform 120 can also be performed on the client devices 110A-110Z in other implementations (and vice versa), if appropriate. In addition, the functionality attributed to a particular component can be performed by different or multiple components operating together. The communication services platform 120 can also be accessed as a service provided to other systems or devices through appropriate APIs.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

FIG. 2 illustrates an example flow of data 200 for generating synthetic messages for training an AI model of a communications services platform 120, in accordance with some implementations of the disclosure. Portions of the data flow 200 may occur at the platform 120 and specifically at the training data generation system 124.

In one embodiment, the data flow 200 may include example messages 210, which can include platform templates 212 and platform-provided messages 214. The example messages 210 may include one or more messages stored by the communication services platform 120 (e.g., stored in the data store 106). An example message 210 may include a message that simulates communications of a customer of the communication services platform 120 with a user associated with the customer. The example messages 210 may include one or more platform templates 212. A platform template 212 may include a template message accessible to customers of the platform 120. The platform template 212 may be an example message that the platform 120 provides to customers of the platform 120 to enable a customer to modify the template to use for the customer's own purposes. A platform template 212 may include one or more blank spaces or other placeholders that a customer can fill in with its own data.

In some implementations, the example messages 210 may include one or more platform-provided messages 214. A platform-provided message 214 may include a message stored by the communication services platform 120 and generated by the communication services platform 120 for use as an example message. In some implementations, the platform-provided message 214 may not include blanks or placeholders but may include simulated (or “dummy”) data that imitates real-world messages sent by customers of the platform 120.

In some implementations, an example message 210 (whether a platform template 212 or a platform-provided message 214) may be associated with a message category. A message category may reflect a use case associated with the message. For example, a message category may be a verification category. A verification message may be utilized in verifying an identity of the recipient end user. Examples of verification messages include messages that include one-time passwords (OTPs), multi-factor authentication (MFA) verification codes, or other data used to verify that a user has requested an action.

In another example, a message category may be a transactional category. A transactional message may be utilized in providing transactional information to the recipient end user. A transactional message may provide a product or service order confirmation, a delivery notification, a user account notification (e.g., a notification that the user's account has been created, changed, or suspended), or other data associated with a transaction associated with the user receiving the message.

In another example, a message category may be a marketing category. A marketing message may provide marketing information to the recipient end user. A marketing message may notify the user about promotions, discounts, events, offers, product or service announcements, or rewards programs. In another example, a message category may be an announcements category. An announcement message may be utilized in notifying a recipient end user about emergency alerts, traffic conditions, service disruptions, public safety campaigns, or other similar events. In one example, a message category may be a customer support category. A customer support message may notify a recipient end user about customer-related issues, including updates to services or products the user has purchased, issue resolution notifications, customer service availability notifications, order confirmations, or the like.

In another example, a message category may be a security/emergency category. A security/emergency message may notify the recipient end user about security-or emergency-related information. A security/emergency message provide information about the security of an account of the end user. For example, a security/emergency message may notify the user about a data breach, a password change or reset, a suspicious transaction, scams, or other security-related information. A security/emergency message may notify the recipient end user about natural disasters, evacuations, public health emergencies, safety warnings, or other emergency-related information. In another example, a message category may be a healthcare category. A healthcare message may be utilized in notifying the recipient end user about healthcare-related information. A healthcare message may notify the user about a healthcare appointment, a vaccine reminder, medical test results, public health alerts, or other healthcare-related information. In another example, other message categories may include categories related to charitable, religious, educational, or political topics, or messages related to general conversations.

The training data generation system 124 may obtain the example messages 210. For example, the training data generation system 124 may retrieve the example messages 210 from the data store 106. The data storing the example messages 210 may include database records, file system files, or other data. In some embodiments, each example message 210 may be associated with a message category. The message category may indicate the use case for the associated example message.

In one embodiment, the training data generation system 124 may provide the example messages 210 to a prompt subsystem 222. The prompt subsystem 222 may generate a prompt that uses one or more of the example messages 210 and that is configured to generate synthetic messages for use in training data. The prompt may specify a message category, and the example messages 210 included in the prompt may be associated with that message category. In one example, the prompt subsystem 222 may use a prompt template to generate the prompt. The prompt template may include pre-generated text and one or more blank spaces or placeholder text, and the prompt subsystem 222 may replace the blanks or the placeholder text with text to customize the prompt. For example, the pre-generated text may include an instruction to generate synthetic messages, and the prompt subsystem 222 may insert one or more of the example messages 210 into the prompt template at the designated blank space or placeholder text. As an example, the prompt template may be:
Generate multiple SMS messages based on the message category and example message(s), below. The generated messages should apply to multiple scenarios and should include realistic details such as names, dates, and websites. The generated SMS messages should closely resemble genuine communications. Message Category: <message category>Sample SMS messages: <the example messages 210>where the text “<message category>” is replaced by the message category of the example message(s) 210, and the text “<the example messages 210>” is replaced by the example messages 210.

In some embodiments, the prompt subsystem 222 may select a message category for generating a prompt. The prompt subsystem 222 may select a message category from a set of predetermined message categories (e.g., the message categories indicated above: verification, transactional, marketing, etc.) where the number of synthetic messages associated with the selected message category is below a threshold number. The prompt subsystem 222 may then select one or more example messages 210 associated with that message category and generate synthetic messages for that category. The prompt subsystem 222 may repeatedly select message categories and generate prompts configured to generate synthetic messages for that message category until the number of synthetic messages for the selected message category exceeds the threshold.

The prompt subsystem 222 may provide a prompt generated by the prompt subsystem 222 to one or more generative AI models 224. A generative AI model 224 may be part of the training data generation system 124 or may be part of another component of the communication services platform 120. In some implementations, a generative AI model 224 may include an LLM or some other AI model that can generate natural language text. The generative AI models 224 may generate multiple synthetic messages based on the prompt.

In some embodiments, the training data generation system 124 may analyze the generated synthetic messages. For example, the training data generation system 124 may determine if the synthetic message contains repetitive text. The training data generation system 124 may determine if the synthetic message is within a threshold similarity to another previously generated synthetic message (which may indicate that the synthetic message is repetitive of the previously generated message). The training data generation system 124 may calculate a cosine similarity to determine if the synthetic message's content is repetitive or if the synthetic message is repetitive of another synthetic message. In some implementations, the training data generation system 124 may detect if the generated synthetic message includes vulgar, hateful, offensive, obscene, or abusive content, or if the message is written in an aggressive or otherwise negative style. For example, the training data generation system 124 may use an AI model (e.g., an LLM) to determine if the synthetic message contains such content, or the AI model may perform a sentiment analysis using the synthetic message as input. The training data generation system 124 may determine if the synthetic message has less than a predetermined minimum text character or word count or exceeds a predetermined text character or word limit. The minimum or limit may be supplied by configuration data of the platform 120. The training data generation system 124 may determine if a phone number, email address, or other identifier conforms to a valid format (e.g., by inputting the identifier into an LLM or a regex). The training data generation system 124 may determine if the synthetic message conforms to a readable structure (e.g., short, informative sentences). For example, the training data generation system 124 may use an LLM to analyze the structure of the message and determine if the message is readable. The training data generation system 124 may determine (e.g., using an LLM) if the synthetic message uses correct punctuation, spelling, spacing, etc. Responsive to detecting that the generated synthetic message does not meet one or more of the above criteria, the training data generation system 124 may discard the synthetic message, modify a prompt template, or modify one or more of the example messages 210 to reduce the likelihood of future generated synthetic messages not meeting such criteria.

In one implementation, the training data generation system 124 may provide the synthetic messages to a pre-processing subsystem 226. The pre-processing subsystem 226 may be employed to prepare the received synthetic messages for inclusion in a training dataset. The pre-processing subsystem 226 may perform named entity recognition (NER). NER may include identifying named entities within a synthetic message. An entity may include a person, organization, location, URI, email address, phone number, date, time, quantity, percentage, currency, code (e.g., an OTP or a verification code), or other data. The pre-processing subsystem 226 may replace an identified named entity with a tag, and the identified named entity may not be derivable from the tag (e.g., the NER process may be a one-way process). The pre-processing subsystem 226 may perform other pre-processing operations on the synthetic messages.

In some implementations, a training data subsystem 228 may receive the pre-processed synthetic messages and may generate training data based on the received pre-processed synthetic messages. Generating the training data may include generating multiple items of training data. Each item of training data may include a synthetic message and a corresponding label identifying the category of the synthetic message. The training data subsystem 228 may collect the multiple items of training data into a training dataset.

In one or more implementations, the training data subsystem 228 may provide the generated training data to one or more AI models 230. The training data generation system 124 may train the AI models 230 using the training dataset to classify messages into one or more categories. Training an AI model 230 may include inputting the training dataset into the AI model 230 so that the AI model 230 can find patterns in the training data and configure itself based on those patterns. Training the AI model 230 may include performing validation testing using some of the data from the training dataset or performing other testing operations.

In one implementation, an AI model 230 may include one or more of artificial neural networks (ANNs), decision trees, random forests, support vector machines (SVMs), clustering-based models, Bayesian networks, or other types of AI models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network. ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, the messaging system 122 may use the trained AI models 230 to classify messages of message forwarding requests. The messaging system 122 may receive, via an API, a message forwarding request from client device 110. The message forwarding request may include data indicating the payload of a message to be sent. The messaging system 122 may provide the payload of the message as input to a trained classification AI model 230. The AI model 230 (or an AI model input subsystem associated with the AI model 230) may generate an embedding based on the message body. The embedding may include representation of the message body in a vector space. The embedding is compatible with the AI model 230. The AI model 230 may perform an inference calculation using the input to generate one or more output values. Each output value may be associated with a message category, and the message category associated with the highest output value may be selected as the classification 232 for the message.

The messaging system 122 may use the classification 232 of the message to determine whether transmitting the message at the current time of day would comply with an acceptable use policy of the communication services platform 120 or applicable laws or regulation. The messaging system 122 may determine the current time of day for the recipient end user. For example, the messaging system 122 may identify a portion of the communication endpoint identifier associated with the recipient end user (e.g., the area code of a phone number), determine a location associated with the portion of the identifier, or the messaging system 122 may retrieve a location for the user from a location storage of the data store 106. The messaging system 122 may look up the current time for the location of the end user and determine if the forwarding the message at the current time would comply with the applicable use policy or applicable laws and regulations. For example, the AI model 230 may classify an input message as a marketing message and may provide that classification 232 to the messaging system 122. The messaging system 122 may determine that the local time for the recipient user of the message is 1 a.m. The messaging system 122 may determine that sending a marketing message between 8 p.m. and 8 a.m. does not comply with applicable law. Thus, the messaging system 122 may delay the sending of the message.

In some embodiments, the messaging system 122 may provide one or more messages received from onboarded customers to the training data generation system 124 to use as example messages 210. An onboarded customer may include a customer of the communication services platform 120 that has been set up for having the messaging system 122 process message forwarding requests (e.g., by having the messaging system 122 forward messages received from such customer). For each message that the messaging system 122 provides as an example message 210, the messaging system 122 may provide the classification 232 associated with the message. The classification 232 may include the classification generated by an AI model 230 trained to classify messages of message forwarding requests received by the platform 120. The prompt subsystem 222 may use these messages and their associated classifications 232 to form generative AI prompts in a process that is similar to the process discussed above in relation to platform-provided messages 214. In some implementations, synthetic messages generated based on the messages provided by customers may be used to generate further training data, which may enhance the training dataset and may be used to retrain the AI models 230 to improve their accuracy.

FIG. 3 depicts a flow diagram of an example method 300 for generating synthetic messages for training an AI model of a communications services platform 120, in accordance with some implementations of the disclosure. In some implementations, method 300 can be performed by the communication services platform 120, and in particular, training data generation system 124.

The method 300 of FIG. 3 and/or each of the method's 300 individual functions, routines, subroutines, or operations can be performed by a processing device, having one or more processing units (CPU) and memory devices communicatively coupled to the CPU(s). In some implementations, the method 300 can be performed by a single processing thread or alternatively by two or more processing threads, each thread executing one or more individual functions, routines, subroutines, or operations of the method. The method 300, as described below, can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations of the method 300 can be modified. Thus, the illustrated implementations should be understood only as examples, and the illustrated operations can be performed in a different order, while some operations can be performed in parallel. Additionally, one or more operations can be omitted. In some implementations. Thus, not all illustrated operations are required in every implementation, and other process flows are possible. In some implementations, the same, different, fewer, or greater operations can be performed. It may be noted that elements of FIG. 1-2 may be used herein to help describe FIG. 3.

At operation 302, processing logic generates, by a communication services platform 120, one or more example messages. The example messages 210 may simulate communications of a customer of the communication services platform 120 with a user associated with the customer. Each example message of the example messages 210 may be associated with a first message category. The example messages 210 may include one or more platform templates 212 or one or more platform-provided messages 214. The first message category may be a verification category. A verification message may include message configured to verify an identity of the user associated with the customer. The first message category may be a transactional category. The first message category may be a security category. A security message may include a message related to the security of an account that is associated with the user associated with the customer. The first message category may be another category discussed herein.

In one implementation, the method 300 may include generating a template message. The template message may include a platform template 212. The template message may be accessible to a customer of the communication services platform 120. For example, a customer may use a client device 110 to access a user interface of the platform 120 that presents the template message on the client device 110. The template message may be associated with the first message category. The method 300 may further include transmitting the template message to the customer. For example, the platform 120 may send the template message over the network 104 to the client device 110 used by the customer. The method 300 may further include receiving data modifying a portion of the template message via a GUI or an API. For example, the customer may use the GUI presented on the client device 110 to fill in a blank in the template message with text. Modifying the template message may include the platform 120 making a copy of the template message and modifying the copy so the original template message can be used by other customers of the platform 120. The method 300 may further include including the modified template message in the example messages.

At operation 304, processing logic generates a prompt that includes a command to generate a synthetic message based on the example messages 210. In some implementations, operation 304 includes the training data generation system 124 using the prompt subsystem 222 to generate the prompt. The prompt may include one or more example messages 210, a category associated with the example messages 210 included in the prompt, and/or the command to generate the synthetic message, as discussed above in relation to FIG. 2. The command may include a command to include realistic details in the synthetic message.

At operation 306, processing logic causes a first AI model prompted by the prompt to generate one or more synthetic messages. The first AI model may include an AI model of the generative AI models 224 of the AI subsystem 220. The first AI model may generate the one or more synthetic messages as discussed above in relation to FIG. 2.

At operation 308, processing logic generates a training dataset that includes the synthetic messages. Each item of the training dataset may include the first message category as the label identifying the category of the synthetic message. Operation 308 may include the pre-processing subsystem 226 pre-processing the synthetic messages as discussed above. Operation 308 may include the training data subsystem 228 generating the training dataset as discussed above.

At operation 310, processing logic trains, using the training dataset, a second AI model to classify input messages into two or more message categories reflecting respective use cases associated with the input messages. The message categories can include the first message category. The second AI model may include the second AI model 230 discussed above in relation to FIG. 2. In one implementation, different items of the training dataset may have different target output labels. For example, a first portion of the training dataset items may have target output labels indicating the items' respective input messages belong to the verification message category, and a second portion of the training dataset items may have target output labels indicating the items' respective input messages belong to the marketing message category. The training dataset may have items with a variety of respective target output labels to train the second AI model 230 to classify input messages into different message categories.

In one implementation, the method 300 further includes causing the second AI model to classify a first message of a messaging request received by the communication services platform into the first message category. For example, as discussed above, the messaging system 122 may use a trained AI model 230 to classify a message of a message forwarding request, which may include a payload of a message to be sent. The messaging system 122 may provide the payload as input to the trained AI model 230, which may perform an inference calculation and generate a classification 232 for the message as an output. The method 300 may further include, in response to determining, based at least in part of the first message category, that the first message complies with a messaging restriction, causing the first message to be transmitted to a communication endpoint indicated by the messaging request. For example, as also discussed above, the messaging system 122 may use the classification 232 of the message to determine whether transmitting the message at the current time of day would comply with an acceptable use policy of the communication services platform 120 or applicable laws or regulation.

In some implementations, the method 300 further includes receiving one or more messages from a customer of the communication services platform 120. The received messages may include one or more messages associated with message forwarding requests received from onboarded customers of the platform, as discussed above. The method 300 may further include generating, at the communication services platform 120, additional training data based on the received messages. The method 300 may further include appending the additional training data to the training dataset.

In one implementation, generating the additional training data includes generating an item of training data. Generating the item of training data can include generating a training data label identifying a message category for one of the messages received from the customer. In one example, the message category can be a classification that was output to a third AI model 230. The third AI model 230 may have received the message as input to generate the classification.

The third AI model 230 may be different than the second AI model 230 discussed above in relation to operation 310. The item of training data may include the message and, as the target output label, the identified message category. As discussed above, using training data based on real messages customers provide to the platform 120 can enhance the training dataset and may be used to retrain the AI models 230 to improve their accuracy.

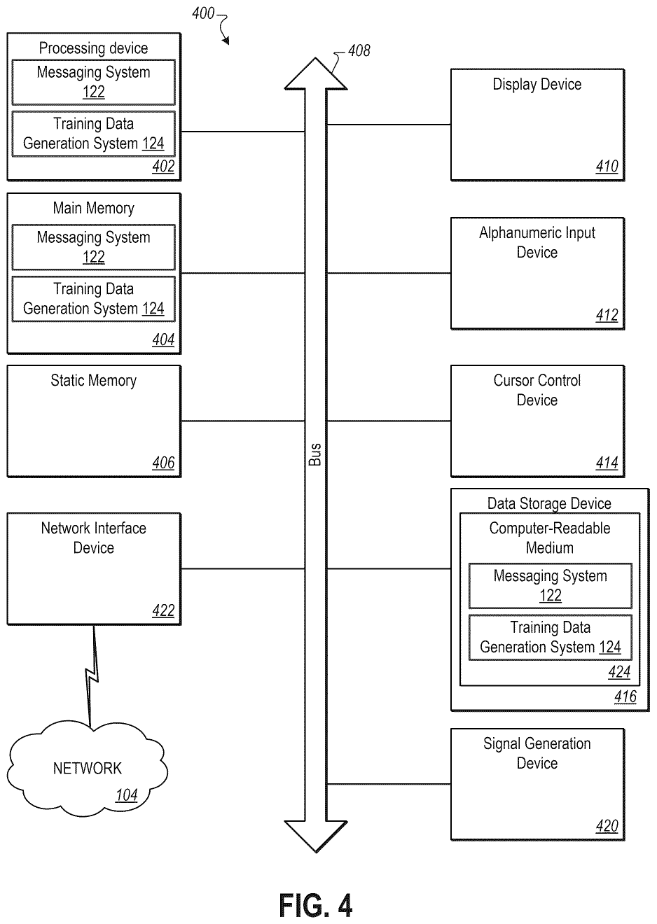

FIG. 4 is a block diagram illustrating an exemplary computer system 400, in accordance with an implementation of the disclosure. The computer system 400 executes one or more sets of instructions that cause the machine to perform any one or more of the methodologies discussed herein. Set of instructions, instructions, and the like may refer to instructions that, when executed by the computer system 400, cause the computer system 400 to perform one or more operations of the messaging system 122 and/or the training data generation system 124. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

The processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions of the system architecture 100, the messaging system 122, and/or the training data generation system 124 for performing the operations discussed herein.

The computer system 400 may further include a network interface device 422 that provides communication with other machines over the network 104, such as a local area network (LAN), an intranet, an extranet, or the Internet. The computer system 400 also may include a display device 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a non-transitory computer-readable storage medium 424 on which is stored the sets of instructions of the system architecture 100, the messaging system 122, and/or the training data generation system 124 embodying any one or more of the methodologies or functions described herein. The sets of instructions of the system architecture 100, the messaging system 122, and/or the training data generation system 124 may also reside, completely or at least partially, within the main memory 404 and/or within the processing device 402 during execution thereof by the computer system 400, the main memory 404 and the processing device 402 also constituting computer-readable storage media. The sets of instructions may further be transmitted or received over the network 418 via the network interface device 422.

While the example of the computer-readable storage medium 424 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “obtaining,” “determining,” “performing,” “suspending,” “disabling,” “providing,” “calculating,” “sending,” “receiving,” “notifying” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
generating, by a communication services platform, one or more example messages simulating communications of a customer of the communication services platform with a user associated with the customer, wherein each example message of the example messages is associated with a first message category;
generating a prompt that includes a command to generate a synthetic message based on the example messages;
causing a first artificial intelligence (AI) model, in response to receiving the prompt, to generate a plurality of synthetic messages;
generating a training dataset comprising the plurality of synthetic messages, wherein each item of the training dataset includes the first message category as a target output label; and
training, using the training dataset, a second AI model to classify input messages into a plurality of message categories reflecting respective use cases associated with the input messages, wherein the plurality of message categories includes the first message category.

2. The method of claim 1, further comprising:
causing the second AI model to classify a first message of a messaging request received by the communication services platform into the first message category; and
in response to determining, based at least in part on the first message category, that the first message complies with a messaging restriction, causing the first message to be transmitted to a communication endpoint indicated by the messaging request.

3. The method of claim 1, wherein the first message category is one of:
a verification category, wherein a message associated with the verification category is sent for verifying an identity of the user;
a transactional category, wherein a message associated with the transactional category is sent for providing transactional information to the user;
a security category, wherein a message associated with the security category providing information about the security of an account that is associated with the user; or
a marketing category, wherein a message associated with the marketing category is sent for providing marketing information to the user.

4. The method of claim 1, further comprising:
generating a template message associated with a first message category of the plurality of message categories;
transmitting the template message to the customer;
receiving, via at least one of a graphical user interface (GUI) or an application programming interface (API), data modifying a portion of the template message; and
including the template message in the example messages.

5. The method of claim 1, wherein the target output labels of the items of the training dataset comprise different messages categories of the plurality of message categories.

6. The method of claim 1, further comprising:
receiving a plurality of messages from a customer of the communication services platform;
generating, by the communication services platform, additional training data based on the plurality of messages; and
appending the additional training data to the training dataset.

7. The method of claim 6, wherein generating an item of training data of the additional training data comprises:
generating a training data label identifying a message category for a message of the plurality of messages received from the customer, wherein the message category includes a classification output by a third AI model in response to using the message as input; and
generating the item of training data, wherein the item comprises the message and, as the target output label, the identified message category.

8. The method of claim 1, further comprising:
detecting an error in a synthetic message of the plurality of synthetic messages; and
modifying at least one of a template associated with the prompt or an example message.

9. A system, comprising:
a memory; and
a processing device, coupled with the memory, configured to perform operations comprising:
generating, by a communication services platform, one or more example messages simulating communications of a customer of the communication services platform with a user associated with the customer, wherein each example message of the example messages is associated with a first message category,
generating a prompt that includes a command to generate a synthetic message based on the example messages,
causing a first artificial intelligence (AI) model, in response to receiving the prompt, to generate a plurality of synthetic messages,
generating a training dataset comprising the plurality of synthetic messages, wherein each item of the training dataset includes the first message category as a target output label, and
training, using the training dataset, a second AI model to classify input messages into a plurality of message categories reflecting respective use cases associated with the input messages, wherein the plurality of message categories includes the first message category.

10. The system of claim 9, wherein the command to generate the plurality of synthetic messages comprises a command to include realistic details in the plurality of synthetic messages.

11. The system of claim 9, wherein the first message category is one of:
a verification category, wherein a message associated with the verification category is sent for verifying an identity of the user;
a transactional category, wherein a message associated with the transactional category is sent for providing transactional information to the user;
a security category, wherein a message associated with the security category is sent for providing information about the security of an account that is associated with the user; or
a marketing category, wherein a message associated with the marketing category is sent for providing marketing information to the user.

12. The system of claim 9, further comprising:
generating a template message associated with a first message category of the plurality of message categories;
transmitting the template message to the customer;
receiving, via at least one of a graphical user interface (GUI) or an application programming interface (API), data modifying a portion of the template message; and
including the template message in the example messages.

13. The system of claim 9, wherein the target output labels of the items of the training dataset comprise different messages categories of the plurality of message categories.

14. The system of claim 9, further comprising:
receiving a plurality of messages from a customer of the communication services platform;
generating, by the communication services platform, additional training data based on the plurality of messages; and
appending the additional training data to the training dataset.

15. The system of claim 14, wherein generating an item of training data of the additional training data comprises:
generating a training data label identifying a message category for a message of the plurality of messages received from the customer, wherein the message category includes a classification output by a third AI model in response to using the message as input; and
generating the item of training data, wherein the item comprises the message and, as the target output label for the item, the identified message category.

16. A computer-readable storage medium comprising instructions that, when executed by a processing device, cause the processing device to perform operations comprising:
generating, by a communication services platform, one or more example messages simulating communications of a customer of the communication services platform with a user associated with the customer, wherein each example message of the example messages is associated with a first message category;
generating a prompt that includes a command to generate a synthetic message based on the example messages;
causing a first artificial intelligence (AI) model, in response to receiving the prompt, to generate a plurality of synthetic messages;
generating a training dataset comprising the plurality of synthetic messages, wherein each item of the training dataset includes the first message category as a target output label; and
training, using the training dataset, a second AI model to classify input messages into a plurality of message categories reflecting respective use cases associated with the input messages, wherein the plurality of message categories includes the first message category.

17. The computer-readable storage medium of claim 16, wherein the command to generate the plurality of synthetic messages comprises a command to include realistic details in the plurality of synthetic messages.

18. The computer-readable storage medium of claim 16, wherein the first message category is one of:
a verification category, wherein a message associated with the verification category is sent for verifying an identity of the user;
a transactional category, wherein a message associated with the transactional category is sent for providing transactional information to the user;
a security category, wherein a message associated with the security category is sent for providing information about the security of an account that is associated with the user; or
a marketing category, wherein a message associated with the marketing category is sent for providing marketing information to the user.

19. The computer-readable storage medium of claim 16, further comprising:
generating a template message associated with a first message category of the plurality of message categories;
transmitting the template message to the customer;
receiving, via at least one of a graphical user interface (GUI) or an application programming interface (API), data modifying a portion of the template message; and
including the template message in the example messages.

20. The computer-readable storage medium of claim 16, wherein the target output labels of the items of the training dataset comprise different messages categories of the plurality of message categories.
